(19) United States
(12) Patent Application Publication
(10) Pub. No.: US 2010/0056630 A1
(43) Pub. Date: Mar. 4, 2010

(54) COMPOSITION FOR THE TREATMENT AND/OR PREVENTION OF FIRE BLIGHT

(75) Inventors: Johannes Gariess, Koln (DE); Georg Geraedts, Bergisch Gladbach (DE); Hans Siebenlist, Schweitenkirchen (DE); Ulf Abele, Hohenwart (DE)

Correspondence Address: LANXESS CORPORATION, 111 RIDC PARK WEST DRIVE, PITTSBURGH, PA, 15275-1112, US

(73) Assignee: LANXESS DISTRIBUTION GMBH, Langenfeld (DE)

(21) Appl. No.: 12/442,135

(22) PCT Filed: Sep. 24, 2007
(86) PCT No.: PCT/EP2007/060078

§ 371 Date: Nov. 6, 2009

(30) Foreign Application Priority Data
Sep. 27, 2006 (DE) 10 2006 045 505.3

(51) Int. Cl. A01N 37/00

(52) U.S. Cl. 514/557

(57) ABSTRACT

The invention relates to an agent for treating and/or preventing fire blight, particularly present in wood and fruit trees, comprising formic acid and/or a salt of formic acid, particularly calcium formiate as an active component. Further disclosed is the use of formic acid and/or a salt of formic acid, particularly calcium formiate as an active component in herbicides, particularly for treating and/or preventing fire blight, and the use of formic acid and/or a salt of formic acid, particularly calcium formiate, for the production of an agent for treating and/or preventing fire blight.

The invention relates to a composition for the treatment and/or prevention of fire blight, in particular in woody species and preferably in woody fruit species, which composition comprises formic acid and/or a salt of formic acid, in particular calcium formate, as active component. It furthermore relates to the use of formic acid and/or a salt of formic acid, in particular calcium formate, as active component of plant protection products, in particular for the treatment and/or prevention of fire blight, and to the use of formic acid and/or a salt of formic acid, in particular calcium formate, for the preparation of a composition for the treatment and/or prevention of fire blight.

### BACKGROUND

Fire blight is a disease of woody fruit and ornamental species caused by the bacterium Erwinia amylovora. The disease is notifiable.

The disease was first found 200 years ago in the east of the USA in apples, pears and quinces; it did not appear in England until 1957. Again, the bacterial pathogen was detected here. In recent decades, the disease has spread rapidly and now poses a serious risk to pome fruit and ornamental species. Since 1993, it has spread in fruit plantations in southern Germany and caused devastating damage. It affects commercial fruit production, traditional, extensively managed orchards—which characterize the countryside—and tree nurseries, domestic gardens and public amenity planting. The disease is dangerous and very difficult to control.

The range of host plants is limited to plants of the rose family with pomaceous fruit (Pomoideae or Rosaceae). The pathogen has been detected in a large number of genera and species of this family. As regards northern and central Europe, host plants are considered to be the cultured and ornamental forms of apple (Malus) and pear (Pyrus) and also pyracantha (Pyracanta), quince (Cydonia), stranvaesia (Stranvaesia), Sorbus species such as sorb apple (Sorbus), white- or red-flowered hawthorn (Crataegus), Japanese quince (Chaenomeles), cotoneaster (Cotoneaster), loquat (Eriobotrya) and medlar (Mespilus). The severity of the disease depends greatly on the weather conditions during the flowering phase of the variety in question.

The bacteria spend the dormant period of the vegetation in diseased bark sections, from where they are dispersed in spring and summer via raindrops, wind and sucking and flower-visiting insects such as honeybees, aphids, psyllids, wasps, bumblebees and flies. Birds, too, are said to play a role in their dissemination. Usually, the disease starts with a floral infection which, as the year goes by, can result in a massive attack of other plant parts (shoots). Important entrance portals for the pathogens are open blossom and wounds, in the case of sufficient moisture also natural openings such as nectar glands, stomata, lenticelles and scars of leaf petioles and of peduncles.

Diseased blossom, shoots and fruits wilt. They initially turn a brown color and, later, usually black at the lesions. Starting from these infection sites, the disease can spread to adjacent shoots, thicker branches and the trunk. The disease usually proceeds rapidly and with great intensity. The affected plants take on a burnt or desiccated appearance. Typical characteristics of fire blight disease are that the stems of the dead blossom and leaves on the diseased branches are in most cases dark brown to black in color and that the main vascular bundles of the leaves are frequently noticeably dark in color. The dead, desiccated leaves and fruits remain hanging on the trees. The diseased young shoot tips, which are initially pale green in appearance, frequently bend in a crook-like fashion as the result of lack of water. In the case of late-flowering woody species and second flushes, the risk of infection is high even in summer. Shoots can also be infected over the entire vegetation period, in particular before the end of shooting. In spring and summer, moist, initially colorless, but later brown, sticky droplets are observed on infected shoots, fruits and rootstock. This infectious bacterial mucus (exudate) is produced in large amounts, in particular under humid-warm conditions. Besides the droplets, filiform structures may also occur. Small or larger dead patches on the trunks and stronger branches can be observed in winter, but frequently also as early as summer or autumn. (“Der Feuerbrand gefährdet Obst-und Ziergehölze” [Fire blight endangers woody fruit and ornamental species], Pflanzenschutzdienst [Plant protection service], Landesanstalt für Pflanzenschutz [Regional institute for plant protection], Stuttgart 2000/2003).

Measures which are recommended for controlling fire blight are mainly regular checks for early identification, and the immediate, consistent removal of diseased plant parts once the first symptoms occur. The removed parts must be burnt immediately. Care must be taken that the tools used are carefully disinfected since transmission may also occur via tools, for example loppers or saws. Also, care must be taken that no other host plants are touched by the removed plant parts. Severely infected plants must be lifted immediately in full and destroyed.

However, these measures, some of which have lead to the brutal digging up of large areas under fruit have proved to be insufficient.

As a rule, the use of conventional plant protection products is insufficient for treating fire blight. Thus, examples of substances which have been tested are resistance inductors (Bion—acibenzolar-S-methyl, Regalis—prohexadione-Ca, Phosfik—phosphorous acid), bacterial antagonists based on Pseudomonas fluorescens (A 506) and Bacillus subtilis (Biopro, FZB, Serenade), rock meal (Mycosin, kaolin, Tec), disinfectants (cetylpyridinium chloride, Menno Florades, hydrogen peroxide), fungicides with a bacterial side effect (dithane-mancozeb, win-capronamid), copper preparations, and combinations of resistance inductors with bacterial antagonists. None of these compositions has shown a sufficient effect in this context. (E. Moltmann, “Feuerbrandbekämpfung in Baden-Württemberg” [The control of fire blight in Baden-Württemberg], Festschrift 50 years Landesanstalt für Pflanzenschutz Stuttgart 2005).

EP-A 0 158 074 discloses the use, for the control of fire blight, of benzisothiazo dioxides which are known as sweeteners.

WO 02/052942 describes the control of fire blight by slaked lime, preferably in the form of an aqueous solution.

DE-A 101 41 774 proposes to coat the plants completely with a liquid latex spray mist in order to thus prevent attack by fire blight.

CA-A-2291984 and U.S. Pat. No. 4,569,841 disclose the control of fire blight by Erwinia herbicola bacteria, WO 2005/048717 the application of “beneficial” bacteria or fungi for this purpose.

EP-A 0 565 266 discloses a combination of a copper complex and a partially neutralized water-soluble polycarboxylic acid for controlling plant diseases caused by bacteria or fungi.

EP-A 1 075 185 proposes a combination of dodine and anilinopyridine for controlling fire blight.

DD-A 273 193 discloses the use of the strepithricin antibiotic Nourseothricin for controlling fire blight, and GB-A 1315430 the use of an antibiotic “A201A”.

DE-A 3640048 describes nitroalkanols for controlling fire blight and also mentions that the use of disinfectants such as benzalkonium chloride is suitable for destroying blossom and therefore eliminates the most important infection option for fire blight.

EP-A 1300078 proposes natural herbal components selected among tea tree oil, oil of wintergreen and eugenol or a mixture of these for controlling fire blight.

U.S. Pat. No. 5,686,389 proposes the use of 5-hydroxylysine or 1,4-diaminobutanone for controlling fire blight and maintains that these active substances are also effective against antibiotic-resistant strains.

JP-A 1090102 discloses β-thujaplicin as agents against fire blight.

For this purpose, JP-A 63099005 proposes poloixin antibiotics in combination with an imidazole compound, while JP-A-57081404 proposes alkoxycarbonyl ureidophenyl.

GP-A-1049116 discloses a tetrahydroxypyrimidine derivative in aqueous solution as composition against fire blight which is allegedly not phytotoxic.

However, all these active substances show no satisfactory results in the control of fire blight.

Relatively good results (efficacies of up to 70%) in the control of fire blight have been obtained with the yeast-containing preparation “Blossom Protect”. Yeast fungi are said to make plants resistant to pathogens as the result of the use of antagonists. The yeast fungi which are employed also occur naturally on fruit and are therefore entirely acceptable for consumer and environment. (Obstbau April 2006, 232). In some fruit varieties, however, this preparation leads to inacceptable russetting of the fruit. Moreover, its compatibility with fungicides is only limited (E. Moltmann, loc. cit.).

Steam treatment and solar treatment, a specific type of insolation by means of black film, do not show a sufficient efficacy either.

Science has therefore only focused firstly on breeding resistant rootstock and fruit varieties. A large number of Plant Breeders' rights for such plant varieties are already in existence. The recombinant generation of transgenic resistant plants has also already been proposed (see, for example, AU-A 670638, U.S. Pat. No. 6,100,453).

A last resort, however, is also the possibility to employ an antibiotic, the streptomycin-coining product Plantomycin (21.1% streptomycin sulfate) (also called Strepto or Firewall 17 WP), under exceptional circumstances and with severe injunctions. Floral infections caused by fire blight can be reduced with an efficacy of from 70 to 90% if streptomycin is used (E. Moltmam, loc. cit.).

Official approval of employing antibiotics in plant production remains unique in Germany. In Switzerland, for example, the use of streptomycin in plant production is illegal. Treatment with streptomycin is only admissible after obtaining written consent, requires extensive limits to be kept, certain pre-harvest intervals must be adhered to, the number of applications during flowering is no more than three, obtaining the product requires a license, the product may only be used by commercial producers, and stringent residue checks are required. These measures are intended to minimize the risks which are generally posed by the use of antibiotics in agriculture. In particular, it is intended to prevent the selection and spreading of streptomycin-resistant fire blight strains. Moreover, there is the risk of streptomycin residues occurring in honey, which is why the latter must be checked carefully. The economical damage is substantial, not only for fruit producers, but also for beekeepers.

While the use of streptomycin for controlling fire blight is in total effective, it is extremely complicated and poses great risks and disadvantages for the environment and the consumer.

Streptomycin is neither suitable nor licensed for use in private gardens and open green spaces, and also in stands of wild-growing woody species, where fire blight spreads massively in particular by infecting the popular ornamental cotoneaster, and hawthorn. No satisfactory composition which would be capable of controlling fire blight exists in particular for these fields of application.

There is therefore an urgent need for a composition for controlling fire blight which firstly has a high efficacy and secondly does not have the abovementioned disadvantages of an antibiotic.

Against this background, the object of the present invention is to provide a composition for preventing and/or treating fire blight.

A subject matter of the invention is therefore firstly a composition for preventing and/or treating fire blight according to claim 1, which comprises, as active component, formic acid and/or a salt of formic acid, in particular calcium formate. Preferred embodiments are indicated in claims 3 to 5. There is furthermore claimed the use of formic acid and/or a salt of formic acid, in particular calcium formate, as active component in plant protection products, preferably for use in woody species and in particular woody fruit species. A subject matter of the invention is furthermore the use of formic acid and/or a salt of formic acid, in particular calcium formate, for the preparation of a composition for treating and/or preventing fire blight.

The composition according to the invention comprises formic acid and/or a salt of formic acid, in particular calcium formate, as active component. This substance is licensed as food preservative (E238) and is therefore entirely acceptable in use.

Formic acid and/or a salt of formic acid, in particular calcium formate, is furthermore licensed as per Düngemittelverordnung [Fertilizer Act] as secondary nutrient fertilizer.

Besides, the composition may comprise other adjuvants and additives conventionally used in plant protection products, such as solid or liquid carriers.

Solvents such as, for example, mono- or polyhydric alcohols, surface-active substances such as anionic surfactants, wetters such as, for example, alkylsulfonates, emulsifiers such as, for example, alkyl carbohydrate esters, dispersants such as, for example, alkylphenol polyglycol ethers, stabilizers such as, for example, celluloses, adhesives such as, for example, paraffinic oils, spreaders such as, for example, isopropyl myristate, buffers such as, for example, hydrogen phosphates, weak acids or bases such as, for example, citric acid or ammonium salts, colorants and fragrances. Furthermore, the composition according to the invention may comprise further active components such as fungicides, bactericides, insecticides, acaricides, growth regulators, plant nutrients such as, for example, secondary nutrient fertilizers.

The composition can be formulated in the customary manner, in solid or liquid form. For example, formic acid and/or a salt of formic acid, in particular calcium formate, can be formulated together with other solid adjuvants in the form of powders, pellets, granules, capsules or tablets, if desired also portionwise, and then packaged, or else it is formulated in liquid form together with the adjuvants and, if appropriate, further active components. Preferably, the composition according to the invention together with the adjuvants and, if appropriate, further active components, is formulated in the form of dust-free microgranules which are then diluted to the use concentration with water, immediately prior to use.

The concentration of formic acid and/or a salt of formic acid, in particular calcium formate, in the granules is, for example, 50-98%, preferably 70-90%, especially preferably approximately 78 to 82% by weight and even more preferably 80% by weight, in each case based on the granules.

Then, the granules are preferably diluted with water to a use concentration of from 0.2 to 15% by weight, preferably 0.5 to 10% by weight and especially preferably from 2.0 to 5.0% by weight, in each case based on the granules.

The pH of the use solution is 3 to 6, preferably 4 to 5.5 and especially preferably 4.5 to 5.

In experiments with a composition according to the invention in apple blossom infected with Erwinia amylovora, an efficacy in the reduction of fire blight of over 80% was achieved with concentrations of 5% by weight and of 10% by weight based on the granules as described in Example 1, the difference between the two concentrations not being significant. Erwinia amylovora in liquid culture was inhibited completely in experiments in which a concentration of 0.25% was used.

It can therefore be assumed that at least 0.5% is required for the application to blossom since experience has shown that blossom experiments require a higher concentration than in liquid culture.

In accordance with the invention, the efficacy is understood as meaning the percentage reduction of the infestation in comparison with plant parts treated with tap water.

The composition according to the invention is applied in the customary manner, for example by spraying or painting on, preferably by spraying. Application to the blossom is preferred. Spraying can take place preventively or else in plants which have already been infected with fire blight. The application can be effected as required, either once or else repeatedly at intervals of from 1 to 14 days, preferably after 3-5 days.

The application takes place in all plants which are susceptible to fire blight, in particular in woody species and here especially preferably woody fruiting species such as apple, pear and quince, but also white- and red-flowered hawthorn, cotoneaster, medlars and the like. Since the composition is entirely acceptable for humans and the environment, the application can not only be effected in commercial fruit production plantings, but also in domestic gardens and public amenity planting or traditional, extensively managed orchards. In this manner, the further spreading of fire blight can be prevented in a simple manner without any environmental risks, as is the case when antibiotics are used.

The examples which follow are given to further illustrate the invention.

### EXAMPLE 1

Test for Inhibitory Activity Against Erwinia amylovora

10 μl of an Erwinia amylovora suspension were plated onto CYE medium at a density of 10⁸ cfu/ml. Thereafter, a hole 5 mm in diameter was punched into the center of the plates, and 20 μl of the test solution were introduced. After 24 hours, the inhibitory zone was measured. The reference substance was streptomycin sulfate, and the negative control was tap water.

The product used was an aqueous solution of the preparation according to the invention in the form of granules of formic acid and/or a salt of formic acid, in particular calcium formiate, whose content in formic acid and/or a salt of formic acid, in particular calcium formate, was approximately 80% by weight. This preparation was diluted with tap water to give the concentrations stated (based on the granules).

### Result

TABLE 1

| | Concentration | Inhibitory zone diameter |
|---|---|---|
| Test substance | [% by weight] | in cm |
| Streptomycin sulfate | 0.1% | 2.4 |
| | 0.01% | 2.0 |
| | 0.001% | 1.6 |
| Solution of the granules | 10% | 2.8 |
| | 10% | 2.8 |
| | 2% | 0 |
| | 2% | 0 |
| | 0.2% | 0 |
| | 0.2% | 0 |
| Tap water | | 0 |

### EXAMPLE 2

Determination of the dose-effect curve of formic acid and/or a salt of formic acid, in particular calcium formate solution, on Erwinia amylovora in liquid culture

Erwinia amylovora strain 385 was plated onto nutrient agar plates (nutrient broth) and incubated at 27° C. After two days, a suspension was prepared using the plates, and the cell density was determined.

To establish the dose-effect curve, graduated concentrations of the test preparation (stock solution: aqueous solution comprising 29% by weight of calcium) were added to nutrient broth liquid medium, and the batches were inoculated with a pathogen number of 10⁷ cells/ml. A batch without test preparation acted as the control. The pH of all batches was determined.

After incubation for 24 hours at 27° C., the number of colony forming units (=cfu) of the pathogen was determined in all batches by plating onto MacConkey agar.

After incubation for 3 days at 27° C., the plates were counted, and the reduction was calculated using the following equation:

REDUCTION %=(1−cfu/cfu control)×100

The test solution used was the same solution as in Example 1, which was diluted with water to the ( ) concentration stated (% by weight based on the final solution).

TABLE 2

| | Solution as in Ex. 1 | | | | | | | | | |
|---|---|---|---|---|---|---|---|---|---|---|
| | 8.0 | 4.0 | 2.0 | 1.0 | 0.5 | 0.25 | 0.2 | 0.125 | 0.0625 | 0.03125 |
| Reduction | 100 | 100 | 100 | 100 | 99.9 | 99.9 | | 0 | 0 | 0 |
| Ea385 | | | | | | | | | | |
| Test 1 | | | | | | | | | | |
| Reduction | 100 | 100 | 100 | 100 | 100 | 100 | 99.9 | 22.7 | 0 | 0 |
| Ea385 | | | | | | | | | | |
| Test 2 | | | | | | | | | | |
| Mean | 100 | 100 | 100 | 100 | 100 | 100 | | 11.4 | 0 | 0 |
| pH | 4.5 | 4.9 | 5.0 | 5.3 | 5.6 | 6.0 | 6.0 | 6.3 | 6.4 | 6.5 |

Up to a concentration of the dissolved granules of 0.25%, Erwinia amylovora in liquid culture is inhibited 100%. Thereafter, the curve drops steeply, and at a concentration of 0.125% virtually no effect is discernible.

### EXAMPLE 3

Determination of the activity of formic acid and/or a salt of formic acid, in particular calcium formate solution, against Erwinia amylovora on apple blossom

Apple blossom cv. Gala of potted trees placed in the open (not treated with plant protection products) were placed with their peduncle into a 10% strength by weight sugar solution and incubated in a humid chamber. 24 blossoms were employed per treatment and replication, and the experiment was replicated four times.

Erwinia amylovora strain 385 was plated onto nutrient agar plates (nutrient broth) and incubated at 27° C. After two days, a suspension with a colony forming unit number of 1×10⁶ cells/ml was prepared using the plates. For the inoculation, the blossoms were sprayed with this suspension.

For the treatment, the blossoms were sprayed with the respective solution one hour post-inoculation, the chamber was sealed, and the material was incubated for 6 days at 20-23° C. One day post-inoculation, the blossoms were treated with the fungicide Euparen (0.15% strength) in order to protect them from attack by mold.

The test solutions used were solutions as in Example 1 with concentrations of 10% by weight and 5% by weight, a streptomycin sulfate solution (Strepto, 0.06% by weight) and, as the control, tap water. The pH values of the solutions of the granules with formic acid and/or a salt of formic acid, in particular calcium formate, were between 4 and 5.

After 6 days had elapsed, the number of blossom with droplets of bacterial slime were counted. The percentage reduction of the infection in comparison with the control treated with tap water was calculated as efficacy for each treatment.

TABLE 3

| | Mean ± standard | Efficacy | | | |
|---|---|---|---|---|---|
| Treatment | deviation | 1 | 2 | 3 | 4 |
| Ca formate solution | 86.4 ± 11.2 | 72.6 | 86.7 | 100.0 | 50.0 |
| (5% by weight granules) | | | | | |
| Ca formate solution | 91.1 ± 12.6 | 100.0 | 73.3 | 100.0 | 100.0 |
| (10% by weight | | | | | |
| granules) | | | | | |
| Strepto | 72.9 ± 4.7 | 70.2 | 66.7 | 76.1 | 78.6 |

The development of symptoms caused by the fire blight pathogen were reduced markedly by both calcium formate concentrations employed in the experiment, giving efficacies of over 80%. The difference between the two concentrations was not significant so that it might be possible to reduce the concentration even further.

At 73%, the plant protection product Strepto had a slightly lower efficacy. However, at a dose of 0.06% by weight of streptomycin sulfate, it was employed at an 80-fold lower dose than in the case of the preparations with 5% by weight of formic acid and/or a salt of formic acid, in particular calcium formate.

1. A composition for preventing and/or treating fire blight, comprising:
an active component, wherein said active component is formic acid and/or a salt of formic acid.

2. The composition according to claim 1, wherein the active component is calcium formate.

3. (canceled)

4. The composition according to claim 1, further comprising:
one or more of conventional adjuvants, solvents, emulsifiers, wetters, adhesives, agents for improving spreading, binders, flow regulators, agents for establishing the pH, complexing agents, stabilizers, antioxidants, or colorants.

5. The composition according to claim 1, further comprising:
one or more further active components.

6-8. (canceled)

9. A process for producing a plant protection composition, comprising:
adding an active component to the plant protection composition, wherein the active component is formic acid and/or a salt of formic acid.

10. The process according to claim 9, wherein the active component is calcium formate.

11. The process according to claim 9, wherein the plant protection composition is capable of protecting stands of woody species.

12. The process according to claim 11, wherein the stands of woody species are stands of woody fruiting species.

13. The process according to claim 9, further comprising:
adding a further active component to the plant protection composition.

14. A process for protecting plants against fire blight, comprising:
contacting the plants to be protected with the composition according to claim 1.

15. A process for protecting plants against fire blight, comprising:
contacting the plants to be protected with the composition according to claim 2.

16. The process according to claim 15, wherein the step of contacting further comprises contacting stands of woody species.

17. The process according to claim 16, wherein the stands of woody species are stands of woody fruiting species

18. The process according to claim 15, further comprising:
adding a further active component to the plant protection composition.
